(19) United States
(12) Patent Application Publication
(10) Pub. No.: US 2013/0288341 A1
(43) Pub. Date: Oct. 31, 2013

(54) MICROBIAL RECLAMATION OF SALINE AND SODIC SOIL

(71) Applicants: Sitaram Prasad Paikray, Greater Kailash-II (IN); Kshyama Singh, Greater Kailash-II (IN)

(72) Inventors: Sitaram Prasad Paikray, Greater Kailash-II (IN); Kshyama Singh, Greater Kailash-II (IN)

(21) Appl. No.: 13/877,432

(22) PCT Filed: Oct. 4, 2010
(86) PCT No.: PCT/IB10/54474

§ 371 Date: Jul. 10, 2013

(51) Int. Cl. B09C 1/10

(52) U.S. Cl. CPC B09C 1/105
USPC 435/252.4; 435/262.5

(57) ABSTRACT

A microbial technology package is disclosed for the reclamation of sodic alkali soils. The method comprises forming an aqueous solution containing mixed microbial composition. The fungus Trichoderma was also included in the technology along with several biological amendments such as molasses and farmyard manure. The technology being based on microorganisms, the treatment is effective and reclaims the soil up to deeper layers. Soils reclaimed by means of microbial treatment may leach out the excess sodium from clay particle improving the soil aggregation, thereby improving water holding capacity and texture of soil. The complete microbial technology package provided in the present invention was successfully reclaimed the soil to normal fertile soil.

### FIELD OF THE INVENTION

The present invention relates to the development of microbial method for the reclamation of sodic alkali soils. More particularly, the microbial methods developed herein involve the optimization of the composition of microbial consortium with particular property of halotolerance, alkalitolerance and acid production, and their effective dose for application. The microbial consortium used in the present invention is the enriched mixed culture of different plant growth promoting bacteria and fungi recovered from sodic alkaline soil and are able to grow at temperature ranged from 3-55° C. as well as at pH 6.5 to 10.5 and salinity up to 10% NaCl.

### BACKGROUND OF THE INVENTION

The problem of sustainable agriculture is increasing continuously, which is a major cause of concern. The major soil agricultural problems are soil sodicity, by which plant growth is either depressed or entirely prevented due to excessive build up of high sodium concentration and/or other cations in the soil, respectively. All over India, a total of 15 million hectares land is affected with the problem of saline sodic soil and termed as Usar’ land. Generations of farmers in these areas have tried coaxing a living from these lands but they remained adamantly barren.

The sodic lands contain high concentration of sodium in their soil. Sodic alkali land all over the country is the major problem in sustainable agriculture. The soils with high Sodium Absorption Ratio (>13; large number of sodium ions on the clay surface) and high pH (>9) are considered as sodic. Often they have a hard calcareous layer at 0.5 to 1 m. depth but real difficulties are encountered in the top 5 centimeters. However saline soil contains high amounts of soluble salts including soil salts, such as sulfates (SO₄), carbonates (CO₃) and chlorides (Cl).

The sodicity causes the clay particles to disperse instead of remaining in their original compact arrangement. The disruption of the soil structure, together with clay dispersion, greatly reduces the soil permeability since the larger pores are blocked. Its dry top soil, as fine and flyaway as talcum powder, hosts no plants and the underlying hardy layer allows no trees to take root. Generations of farmers in these areas have tried coaxing a living from these lands but they remained adamantly barren.

The problems of increasing sodicity, salinity and water logging of soils are clear indications that the modern ways of cropping system and managing soils are not sustainable.

A variety of methods involving the chemical treatment of soils with calcium salts, or other di- or poly-valent cation-containing compounds, have historically been used in attempts to correct sodium-induced dispersion of clay aggregates. As well, the cultivation of salt tolerant crops and physical treatments like leaching and drainage are at times used to assist in removal of sodium ions from sodium contaminated soils while providing some degree of agricultural productivity during reclamation.

The most commonly used chemical for treatment of sodium contaminated soils has traditionally been gypsum (CaSO₄), due both to availability and low cost. Conventionally, the gypsum is applied to the surface of the soil and then incorporated by employing normal cultivation practices. Eventually the gypsum is dissolved either by the native soil moisture, by irrigation water or by natural precipitation, or a combination thereof. Calcium ions thereby brought into aqueous solution displace sodium ions from the exchange complex of the soil by ion exchange as the calcium-enriched water percolates through the soil.

There is however a number of disadvantages which restrict the use of gypsum for the reclamation of sodium contaminated soils. By way of example, gypsum has only low water solubility, such that the concentration that can be dissolved in the soil water may not be sufficient to permit exchange of enough sodium ions to cause reaggregation of deeper subsoils because most of the calcium ions are depleted from the soil water prior to any substantial downward percolation.

Conventionally, gypsum (CaSO₄) is being used for the reclamation of sodic and saline soils. However, the cost of restoring sodic/alkali land by chemical use (gypsum) is virtually huge for permanent cure. Application of gypsum to sodic soils will provide calcium (Ca) to displace sodium (Na). However, one still needs rainfall or irrigation to leach the displaced sodium down and secondly, internal drainage to allow downward movement out of the root zone. If either of these conditions is lacking, then gypsum application alone is fruitless. Moreover, Gypsum (CaSO₄) itself is a salt and accordingly its repeated application to salt affected soil may not be beneficial. In turn it may actually increase the salt content of the soil under reclamation.

Alkaline sodic soils cover approximately 60% of India's cropping regions. These soils constitute a problem because their high pH and Na levels cause clay swelling and dispersion, leading to a reduction in crop yields. Losses due to sodic soils are estimated at $1.1 billion per year, and remediation of these soils to increase yields would be extremely beneficial to local economies. One potential remediation method involves the stimulation of microbial population in sodic soils to produce acid, or acid producing microbial population in sodic soils, thereby decreasing the soil pH and releasing calcium, which helps in soil aggregation and prevent soil dispersion.

The present invention is directed towards the development of a microbial technology package to make the use of these ‘Usar’ land (pH 10.5, electrical conductivity 2.1 and SAR >13) for agricultural cultivation. The composition developed herein employs the use of microbial consortium and farmyard manure/organic manure/agricultural waste and sugar/molasses and or jaggery. Manures will increase the organic matter content of the sodic soil while at the same time sugar will provide the nutrient to microbes for their multiplication and enrichment in the same soil.

The microbial composition developed herein will promote exchange of sodium ions from clay particle followed by leaching, which will result in an improvement in soil aggregation property. Moreover, the production of acid by the developed composition lowers down the pH of soil from alkalinity towards normality.

Molasses and farmyard manure are the rich source of nutrients for the growth and survival of microorganisms. These components are being used in agriculture either independently or in combination of other amendments, for increased crop productivity but a combination of all these in a particular manner and organized way are defined in the present invention for the reclamation purpose.

U.S. Pat. No. 4,687,505 discloses a process for desalination and reclamation of irrigated soil comprising applying to the soil an aqueous solution of an anionic polymaleic anhydride compound having threshold properties or the neutral water soluble salts thereof to treat irrigated soil.

U.S. Pat. No. 4,755,206 discloses a method of productively reclaiming sodium contaminated soils using stable the solution of calcium or magnesium salt with a water soluble anionic polyacrylamide polymer, all in a particular concentration and ratio.

U.S. Pat. No. 5,221,312 relates to water and soil treatment methods for alkaline wherein SO.sub.2 is injected into the aqueous media until a pH of between 5.5 to 6.9 is achieved.

However, the use of microorganisms for the sodic soil reclamation has not yet been reported. Microbes are most abundant entity in the universe. The use of microbial based products will improve the soil quality by reducing the sodium concentration in long term. Halotolerant, alkalitolerant microbes, which are used to make microbial composition, are able to dissolve the sodium and other cation complexes by producing organic acids. Further they can utilize the free sodium and other salts. The microorganisms are able to grow in deeper soil layer and reclaim the soil into sub-surface layers. For this purpose, the microorganisms present in composition/formulation are recommended. Along with this, production of plant growth promoting substances by the microbes presents in the composition increase the plant growth

It is therefore desirable to have a method for reclamation of noncultivable sodic soil which is relatively inexpensive, easy to perform, and effective to remove the salts and/or alkalis in order to enhance crop yield. Moreover, the reclamation of such soil will improve the productive land and can increase the growth rate of agriculture sector being biggest economic sector contributing increased GDP.

It is an object of the present invention to overcome or at least alleviate one or more of the above-mentioned disadvantages of the prior art.

### OBJECT AND SCOPE OF THE INVENTION

The principal object of the present invention is to provide methods and composition of reclamation of sodic alkali soil using a microbial consortium/composition which are inexpensive to produce and easy in effective use.

Another object of the invention relates to microbial consortium which comprises of both bacteria and fungi.

Yet another object of the invention relates to the selection and optimization of alkalitolerant, halotolerant and acid producing, plant growth promoting microorganisms from affected/problematic soil and of the combination thereof.

Still another object of the invention relates to the enrichment and multiplication of alkalitolerant, halotolerant and acid-producing plant growth promoting microorganisms with Farm Yard Manure/organic manure/agricultural waste and sugar/molasses/jaggery in the affected land, either individually or combination thereof.

Further still it is an object of the present invention to provide methods and compositions which are inexpensive to produce and use. Altogether, a microbial technology package is developed and recommended for the reclamation of sodic alkali soil.

These and other objects will become increasingly apparent by reference to the following description.

### STATEMENT OF THE INVENTION

Accordingly the invention provides a method of productively reclaiming sodium contaminated soils of high pH, by microbial composition. Soil reclaimed by means of the present invention display marked improvement in physico-chemical properties, by virtue of exchange of the sodium ions from the exchange complex of the soil and the subsequent leaching away thereof, improving soil aggregation and water holding capacity.

### SUMMARY OF THE INVENTION

The present invention provides an improved method for reclamation of sodic alkali deposits of uncultivable soil with high pH and sodium absorption ration. The method provides the use of consortium of alkalitolerant, halotolerant and acid producing microbial composition of bacteria and fungi that lowers down the soil alkalinity towards normality, and also enhances soil fertility. The microbial composition reduces sodium absorption ration, displays exchange of the sodium ions from the exchange complex of the soil and the subsequent leaching from clay particles, improving soil aggregation, thereby improving water holding capacity and texture of soil.

Further aspects of the invention will become apparent from consideration of the ensuing description of further embodiments of the invention. A person skilled in the art will realize that other embodiments of the invention are possible and that the details of the invention can be modified in a number of respects, all without departing from the inventive concept. Thus, the following descriptions are to be regarded as illustrative in nature and not restrictive.

### DETAILED DESCRIPTION OF THE INVENTION

Alkaline sodic soils cover approximately 60% of India's cropping regions. These soils constitute a problem because their high pH and Na levels cause clay swelling and dispersion, leading to a reduction in crop yields. Losses due to sodic soils are estimated at $1.1 billion per year, and remediation of these soils to increase yields would be extremely beneficial to local economy. One potential remediation method involves the stimulation of microbial population in sodic soils to produce acid, thereby decreasing the soil pH and releasing calcium, which helps to prevent soil dispersion.

The first objective was to determine the alkalitolerance, halotolerance and acid-producing capabilities of microbial populations cultured from alkaline sodic soils. The second objective was to investigate the microbial reactions involved during the amelioration of alkaline sodic soils with glucose, and soils ameliorated with complex organic substrates such as molasses and wheat straw.

The formulation has been found to be effective in soil reclamation along with plant growth promotion shown. Due to the novel microbial combination of Pseudomonas sp, Trichoderma herzianum sp, Micrococcus sp. Kocuria sp. Bacillus sp. Kocuria carniphila, with an accession number MTCC 5525, MTCC 5530, MTCC 5534, MTCC 5535, MTCC 5536, MTCC 5537, respectively, the formulation of the invention provides an economical and effective alternative to conventional “fertilizer”/“chemical” intensive growing systems.

Accordingly the present invention is an improved method for reclamation of sodic alkaline soils by microbial composition.

In accordance with the present invention, the microbial composition comprises of bacteria and fungi which acts as a multi-functional soil amendment.

Accordingly the present invention, provide methods and compositions which are inexpensive to produce and use and which are very effective.

In accordance with the present invention, the soil is treated with microbial consortium fermented and enriched with FYM/organic manure/agricultural waste and sugar/jaggery/Molasses or other organic nutrients. Thus soil in which salts and/or alkali have reached the concentration that whitish deposit appeared on its surface and on which crop growth was unacceptable low is restored to useful fertility level.

In an embodiment of the present invention, the said microbial consortium is provided in a composition suitable for reclamation followed by their application as plant growth promoter by applying to soil or seed treatment directly to soil. The suitable carrier used in the invention is the powder.

In this embodiment, several components present in the suitable carrier are growth supporting substances and the substances that maintains longer shelf life of the microorganisms present in consortium.

In another embodiment of the present invention, the composition contains the microbial cells in 10⁸-10⁹ CFU per gram of the carrier.

The present invention provides exemplary isolates of soil bacterial strains and fungal strains as described herein.

Specifically, the present invention provides an isolated Pseudomonas fluorescens MTCC 5525 bacterial strain having accession number

The present invention provides an isolated Bacillus sp. MTCC 5536 bacterial strain having accession number

The present invention provides an isolated Trichoderma herzianum MTCC 5530 fungal strain having accession number.

The present invention provides an isolated Micrococcus sp MTCC 5534 bacterial strain having accession number.

The present invention provides an isolated Kocuria sp MTCC 5535 bacterial strain having accession number.

The present invention provides an isolated Kocuria carniphila MTCC 5537 bacterial strain having accession number.

The process according to the present invention for the reclamation of sodic and saline soil is described comprising the following steps of:
1. The microbial culture used in the method of present invention is the mixed enriched culture isolated sodic soil (pH>10) of Kakori block, Lucknow, Uttar Pradesh selected by its ability to grow and survive on high stress of sodium ion concentration and pH. A sample of soil from UP ‘Usar’ land was inoculated in aqueous medium containing minimal salts. The pH of the medium was adjusted to 10.5. The salinity was maintained 10% using NaCl. The enrichment was carried out at 37° C. for 4 days. The microorganisms were isolated on the agar plates by dilution plate techniques. The organisms are able to grow at the temperature range of 30-55° C., can grow happily at pH 10.5 and salinity 10%.
2. The same sample was also enriched for the selection of salt tolerant fungi. The only fungi obtained after plating is Trichoderma sp., which was able to grow at temperature 25-37° C., pH 5.5 to 10.5, 8. The same fungus is also able to grow at 10% salinity level.
3. The Microbial consortia of 10⁹ colony forming unit (cfu) along with jaggery/molasses/sugar and Farm Yard Manure (FYM)/organic manure/agricultural waste were applied with the affected soil. Microbial consortium is propagated well in the presence of these biological amendments and lower down the pH of soil from 10.5 to 7.6±0.4. These biological amendments were served as nutrient source for the growth of microbes present in the consortia and in the soil. Moreover, the sugar/molasses/jaggery used in the mixture will be metabolized and resulted in acid production. The microbial composition developed in powder form in suitable carrier and other substances to improve shelf life of the microorganism in the said composition.

For the decrease in soil pH and sodicity, sodium ion concentration was measured in terms of sodium absorption ration. Salinity and pH are estimated by measuring electrical conductivity and pH, respectively.

The following examples of reclamation of saline and sodic soils in accordance with the integrated biological process of this invention are set forth in considerable detail as to conditions and materials and should not be considered as limiting the invention in any way. Reclamation of sodic alkali soil treated in accordance with the examples set forth herein below by microbial composition thereof.

### EXAMPLE I

First, soil suspension was prepared in 2 liters flask, and 1 liter tap water and 1 gram of NaOH was added to it. Now added 100 gram of high pH sodic soil sample and stirred on magnetic stirrer for two hour. Prepared the serial dilutions of soil suspension and plate it on the molasses salt medium. The medium used for the isolation of microbial colonies contained (per L): Molasses 1-5 gram, Sodium phosphate di or tri salt 10-15 gram, ammonium nitrate 1-5 gram, agar 15 gram, pH of the medium was adjusted to 10.5.

### EXAMPLE II

The salinity and pH tolerant bacterial isolates were tested for plant growth promoting properties, auxins production and for phosphate solubilization activity. The efficient strains fulfilling all these criteria were screened out. Individual microbe was inoculated to the sodic soil samples collected from different areas of Uttar Pradesh. The pH, EC and salinity of test soil were measured at 10 days intervals.

The strains and their formulations were selected having capability to significantly reduce all these parameters. Uninoculated tubes were served as control.

### EXAMPLE III

For treatment of sodic alkaline soil, the soil was mixed with one percent jaggery, and one percent Farm Yard Manure and water were sprinkled to maintain moisture. Followed by this, microbial strain grown as pure culture was mixed to maintain 10⁸ cfu per gram of soil. Placed the inoculated pots outside in sun or on the bench for a week. The uninoculated pots of soil were also maintained as control. The experiment was performed in triplicate.

### EXAMPLE IV

The pure culture of organisms showed potential effect in soil reclamation was selected to make consortium. All the strains were grown separately and mixed in the soil for treatment along with FYM and jaggery. Likewise, fungi Trichoderma was also grown in Jaggery and sodium nitrate medium, pH 10.5 and applied to soil. The experiment was performed in 1 kg pots in five replicates. Soil pH, electrical conductivity and sodium absorption ratio was monitored at regular time interval. The soil physico chemical properties such as soil texture and water holding capacity was also monitored. A control without treatment was also maintained.

### EXAMPLE V

Test for antagonism and pathogenicity of bacterial strains: microbial strains selected to prepare consortium was plated on molasses agar media [Molasses 1-5 gram, Sodium phosphate di or tri salt 10-15 gram, ammonium nitrate 1-5 gram, agar 15 gram, pH of the medium was adjusted to 10.5 using NaOH adjacent to one another while placing fungal disk at the centre of the plate. No antagonistic relation was seen among bacteria present in the mixture.

### EXAMPLE VI

For pathogenicity test of these microbial strains, wheat seeds was surface sterilized and soaked in the single bacterial suspension (10⁸ CFU) followed by sowing in sterilized soil. Inoculated soils were observed for any disease or deformity. The test was performed in pots in five replicate. 10 seeds per 1 kg soil per pot were sown. There was no disease symptoms were appeared in the inoculated seed and comparable with healthy plants of uninoculated controls.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the spirit or scope of the present invention as defined.

We claim:

1. A method of productively reclaiming sodium contaminated soil with microbial composition of heterotrophic bacteria and fungi balancing the ionic concentration in the soil, lowering down soil pH from 10.5 to 8.0±0.5 making the soil suitable for cultivation.

2. The microbial composition according to claim 1, further comprising bacteria and fungi.

3. A microbial composition as claimed in claim 1 is a synergistic composition for soil reclamation wherein the said composition comprising of either individual or a combination thereof Pseudomonas sp, Trichoderma herzianum sp, Micrococcus sp. Kocuria sp. Bacillus sp. Kocuria carniphila, with an accession number MTCC 5525, MTCC 5530, MTCC 5534, MTCC 5535, MTCC 5536, MTCC 5537, respectively.

4. An improved microbial method according to claim 1, to reduce the SAR from 45 to 50 and pH from 10.5 to 8.0±0.5, of soil.

5. A microbial composition for soil reclamation according to claim 1, wherein consortium is applied to the soil twice or thrice at twenty day interval until a pH of 8.0±0.5 and SAR<13 is achieved.

6. A microbial method of sodic soil reclamation according to claim 1, display exchange of the sodium ions from cation exchange complex of the soil and the subsequent leaching from clay particles, improving soil aggregation, thereby improving water holding capacity.

7. The method according to claim 1, wherein said composition is added to soil as fermentation product having a microbial mixture of 1.0 percent to about 5 percent and water for proper contact of said mixture with soil.

8. The microbial composition according to claim 1, are first mixed with fermenting material and water to increase the population count of microorganisms before trial.

9. The fermenting material according to claim 8, is organic manure and or farm yard manure and or agriculture waste along with sugar and or jaggery and or molasses with water to make thick slurry.

10. The organisms according to claim 3 are alkalitolerant, halotolerant and acid producing strains which lowers down the soil pH from alkaline 10.5 to 8.0±0.5

11. The microbial composition of claim 2, wherein the said carrier is powder.

12. The microbial composition as claimed in claim 2, wherein the said powder carrier comprises of talcum and/or aluminum silicate and/or a mixture thereof.

13. The beneficial bacterial isolates as claimed in claim 1, herein are Pseudomonas fluorescens, Micrococcus sp. Kocuria sp. Bacillus sp. Kocuria carniphila

14. The beneficial fungal isolates as claimed in claim 1, herein are Trichoderma herzianum, or Trichoderma viride or combination thereof.

15. The method of reclamation as claimed in claim 1, wherein the microbial composition, amends and rejuvenator the soil

16. A method imparting to soil microbial consortium as in claim 1 comprising application to direct soil before sowing, soil surrounding plants and as seed treatment.

17. A microbial method for reclamation plant growth, comprising, a) providing, i) A microbial formulation, wherein said formulation comprises a mixture selected from the group consisting of a bacterial mixture having accession number and a fungal mixture having accession number, and ii) a multiplying agent, and b) applying said microbial formulation to soil for reclamation of saline soil

18. The multiplication of microbial population as claimed in claim 17, wherein the multiplying agent is agriculture waste/organic manure/farm yard manure and glucose/jaggary/molasses.

19. The method imparting to the consortium application comprising on-site enrichment and multiplication of microbial population.
